(19) United States
(12) Patent Application Publication
(10) Pub. No.: US 2012/0219341 A1
(43) Pub. Date: Aug. 30, 2012

(54) Preheat Platen Skin

(76) Inventors: Tania Wolanski, Boulder, CO (US); Joseph Spencer, Longmont, CO (US)

(21) Appl. No.: 13/034,218

(22) Filed: Feb. 24, 2011

(51) Int. Cl. B41J 2/315

(52) U.S. Cl. 400/120.08

(57) ABSTRACT

A print engine is disclosed. The print engine includes a transfer medium to apply print content to a print medium, a preheat platen to heat the print medium prior to applying the print content and a substrate formed to cover the preheat platen.

### FIELD OF THE INVENTION

The invention relates to the field of printing, and in particular, to maintaining a printing system.

### BACKGROUND

In the printing industry, it is sometimes necessary to process media multiple times in order to create a final product. For example, media such as paper may be pre-printed in an offset press and subsequently run through a digital press/printer in order to add unique (variable) information. In other instances, a digital printer may not have enough capability (e.g., an ink jet printer may not be able to print Magnetic Ink Character Recognition (MICR), or a monochrome printer may not be able to print color/highlight color).

In these cases, it may be necessary to process the media through multiple, independent digital printing devices (e.g., first and second print engines) in order to achieve the final product. Upon entering the second print engine the print medium passes through a preheat platen that heats the medium to an appropriate temperature prior to print content (e.g., toner, ink, dye, etc.) being applied.

However if the platen is not covered, print content applied at the first print engine may melt while passing over the platen. This may lead to the print content to adhering to the platen, causing the medium itself to stick to the platen, thus, interfering with print operations and degrading print quality. As a result, frequent cleaning of the preheat platen is necessary. Preheat platen cleaning is time consuming, often requiring an on site service person to perform the task or at the very least, results in a disruption of print processes and down time while the cleaning operation is performed.

Conventional preheat platens implement a Teflon mat that covers the platen to prevent melting of the print content on the medium. Nonetheless, Teflon mats are thermally insulative and thus reduce heat transfer to the print medium. Moreover, Teflon mats have a relatively short usage span (e.g., 100-200 K ft) and must be often replaced.

Accordingly, an efficient preheat platen skin is desired.

### SUMMARY

In one embodiment, a print engine is disclosed. The print engine includes a transfer medium to apply print content to a print medium, a preheat platen to heat the print medium prior to applying the print content and a substrate formed to cover the preheat platen.

In another embodiment, a printing system is disclosed. The printing system includes a first print engine to print first content on a web of paper and a second print engine to print second content on the web of paper. The second print engine includes a preheat platen to heat the web of paper prior to applying the second content and a substrate formed to cover the preheat platen to prevent melting of the first content.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 illustrates one embodiment of a printer paper path;

FIG. 3 illustrates one embodiment of a print engine; and

FIG. 4 illustrates one embodiment of a preheat platen skin.

### DETAILED DESCRIPTION

A preheat platen skin is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

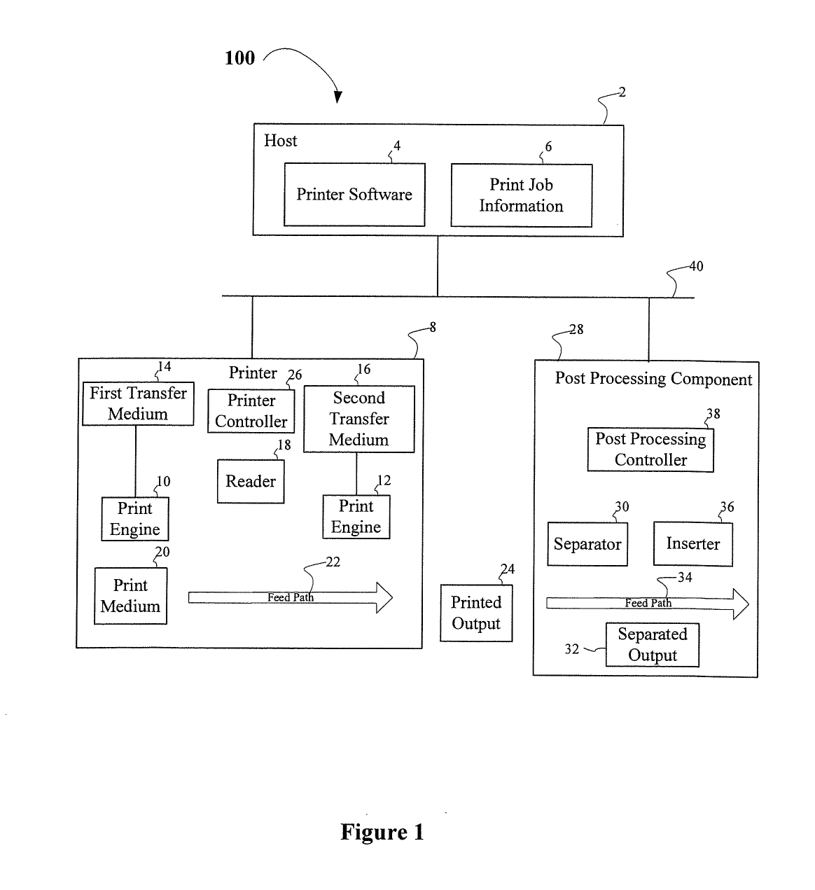

FIG. 1 illustrates one embodiment of a printing system 100. Printing system 100 includes a host system 2 having print software 4 to manage print jobs and to maintain print job information 6 on the status of print jobs managed by the print software. In one embodiment, print software 4 may be implemented using either InfoPrint Manager (IPM) or InfoPrint ProcessDirector (IPPD), although other types of printing software may be used instead.

The term print job as used herein refers a print job or any component thereof, including a page of print content, a page including multiple print items or elements, such as checks, pages, an element on a page, etc. The print job may further include one or more pages, where each page has one or more elements, e.g., checks. A page may include a unit of print output, where the page may be outputted on a single piece of paper or multiple pages may be outputted on a roll, ribbon or web of paper.

Pages may be outputted on a web of paper in different formats, such as 2-up duplex. Each of the pages on a web or roll of paper may include multiple elements. The web of paper may include print jobs, where each print job is one or more pages, and where each page includes one or more elements. In this way, elements and pages may be grouped in print jobs.

The host system 2 may include a processor (not shown) and memory (not shown) in which the print software 4 and print job information 6 is stored for access by the processor. The host system 2 communicates print jobs to the printer 8, where each print job may have one or more pages or elements, and where each page may have one or more elements. The printer 8 includes a first print engine 10 and second print engine 12 to print output using first 14 and second 16 types of transfer media and a reader 18 capable of reading content printed using the first transfer medium 14.

Transfer media 14 and 16 include the material or energy that is used to cause the formation of content on the print medium 20, such as toner, liquid ink, solid ink, dye, wax, heat (which when applied to thermal paper produces the print content), etc. A print medium 20, such as a piece of paper or other material or textile, is directed through a feed path 22 by mechanical components of the printer 8, such as rollers, guides, etc. In the feed path 22, the first print engine 10 prints first content of the one or more pages of one or more print jobs on print medium 20 using first transfer medium 14. The first content that is printed may comprise an element, a page, a page of elements, etc.

The reader 18 reads the printed first print content to determine the quality of the output. The reader 18 may read each element on one or more pages to determine the quality of each outputted element. The reader 18 forwards the print medium 20 to the second print engine 12 to print second content using the second transfer medium 16 to produce printed output 24 including one or more print jobs of one or more pages having one or more elements printed using both types 14 and 16 of transfer media.

The printer 8 may include a printer controller 26 to control printing operations and interface with the printer software 4 to execute the commands from the printer software 4 and provide feedback thereto. The print engines 10 and 12 may include the hardware and/or software to control the printing of content using the first 14 and second 16 types of transfer media, respectively.

The printed output 24 is forwarded to a post processing component 28 which performs various post processing operations on the printed output 24. The additional post processing performed on the separated output 32 pieces may include stapling, collating, printing, labeling, etc. The post processing component 28 then outputs the separated output 32 in a final form, which may comprise envelopes including the separated output 32 pieces. The post processing component 28 may include a post processing controller 38 to control post processing operations and interface with the printer controller 26 and printer software 4 to execute the commands from the printer software 4 and provide feedback thereto.

An interface 40 provides intercommunication among the host 2, the printer 8, and the post processing component 20. The interface 40 may include a network, such as a Local Area Network (LAN), a Wide Area Network (WAN), a wireless network, etc. Alternatively, the interface 40 may include a bus interface, parallel interface, serial interface, or other direct line connection. In the embodiment of described herein, the host 2, printer 8, and post processing component 20 are shown as included in separate boxes. In an alternative implementation, the printer 8 and post processing component 20 may be included in a single machine connected via one connection to the host 2. Alternatively, all three devices 2, 8, and 20 may be included in one machine.

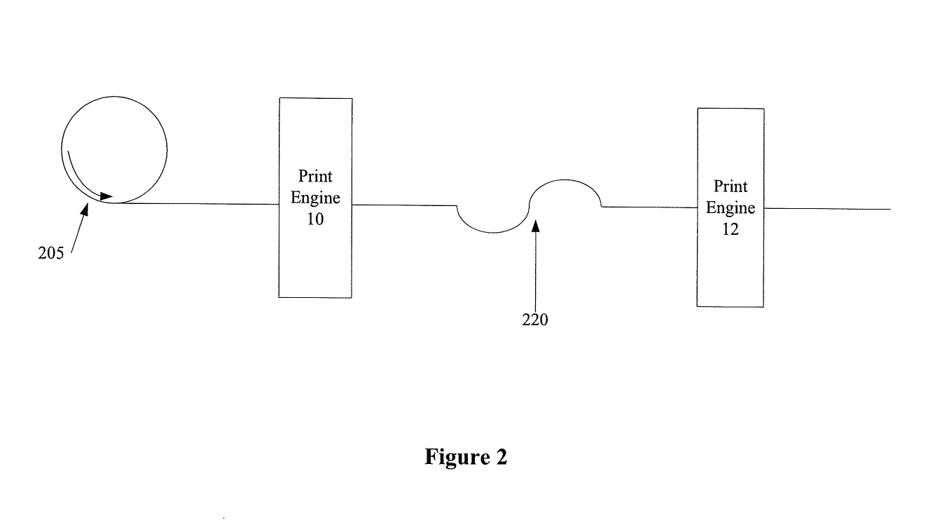

FIG. 2 illustrates one embodiment of the printer 8 paper path. As shown in FIG. 2, the paper path begins with a paper roll 205 that provides the paper web to print engine 10. In one embodiment, print engine 10 prints data onto the top side of the paper web. Upon exiting print engine 10 the paper web is flipped by an air flipper 220 to prepare for print engine 12 to print on the second side of the paper web.

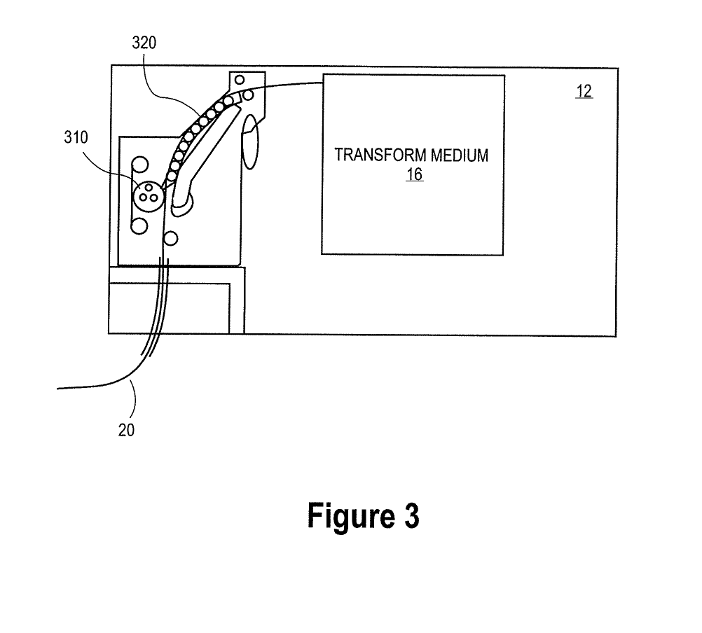

FIG. 3 illustrates one embodiment of print engine 12, which includes transfer medium 16, roll 310 and preheat platen 320. Roll 310 guides medium 20 over preheat platen 320 to be heated for printing at transfer medium 16. As discussed above, platen 320, when not covered, causes print content to melt and adhere to platen 320, which causes medium 20 itself to stick to platen 320.

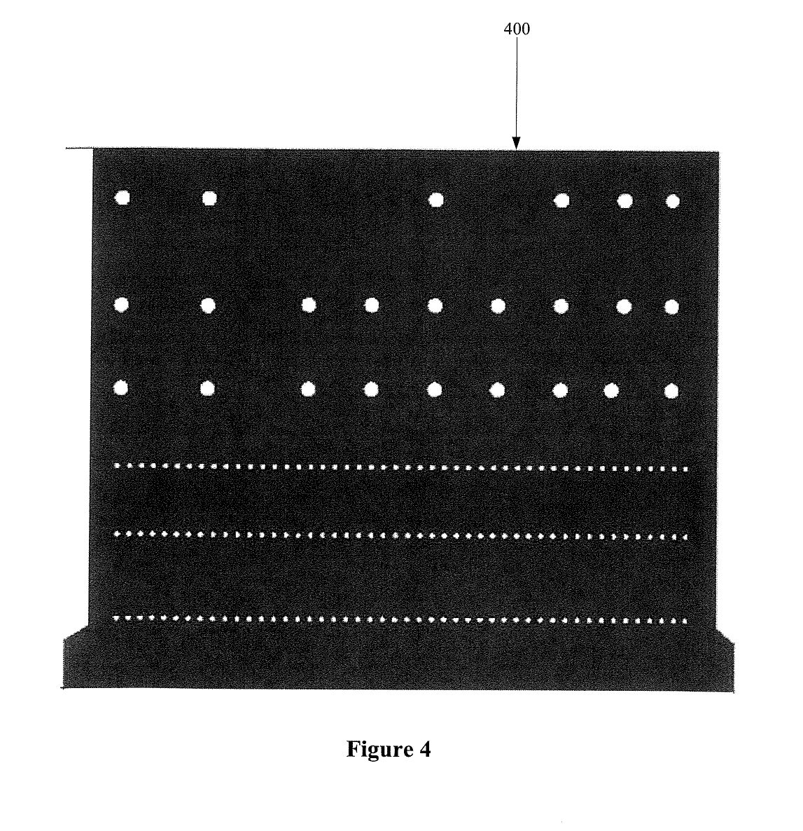

According to one embodiment, a flexible nonstick skin attaches on top of preheat platen 320. FIG. 4 illustrates one embodiment of a platen skin 400. Platen skin 400 includes a metal substrate formed in dimensions similar preheat platen 320. In one embodiment, the substrate material is thermally conductive. As a result, lower preheat temperature settings may be used at platen 320 to obtain good fusing since heat can easily pass through the skin to medium 20. In other embodiments, the substrate may be implemented using other conductive materials.

Further, platen skin 400 is electrically conductive. In such an embodiment, skin 400 has a high surface conductivity (e.g., >10⁸ Ω/sq in.) capable of dissipating static electricity buildup in order to prevent medium 20 from sticking to preheat platen 320. According to one embodiment, the substrate includes holes that provide for vacuum and screw attachment. The vacuum provides a suction that enables the print medium to maintain contact with preheat platen 320.

Coating material may also be in the static dissipative range. A conductive material may be a material with surface resistivity less than 10⁶ ohms per square or volume resistivity less than 10⁵ ohms. A static dissipative material is a material having a surface resistivity greater then 1×10⁶ ohms/square or 1×10⁵ ohm-cm volume resistivity but less than 1×10¹² ohms/square surface resistivity or 1×10¹¹ ohm-cm volume resistivity.

In a further embodiment, the top of skin 400 is coated with a nonstick coating to provide a nonstick property in order to reduce surface energy and permit toner (or ink) to easily release from the surface of skin 400 as medium 20 passes over preheat platen 320. In such an embodiment, the coating is comprised of a high contact angle, low surface energy materials (e.g., polymers or fluoropolymers, inorganics or composites).

Platen skin 400 eliminates the surface adhesion of toner/ink/adhesive to the preheat platen, facilitating printing on heavier stocks and eliminating or significantly reducing the amount of cleaning needed in the preheat platen area. Moreover, skin 400 is durable, having and has exhibited long life (e.g., in excess of 2,000,000 feet). In other embodiments, platen skin 400 may also be included at print engine 10 to prevent adhesive or inks on pre-printed forms from building up on the platen 320.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A print engine comprising:
a transfer medium to apply print content to a print medium;
a preheat platen to heat the print medium prior to applying the print content; and
a substrate formed to cover the preheat platen.

2. The print engine of claim 1 wherein the substrate is thermally conductive to enable heat to pass from the preheat platen to the print through the substrate.

3. The print engine of claim 2 wherein the substrate is electrically conductive.

4. The print engine of claim 3 wherein the substrate has a high surface conductivity capable of dissipating static electricity buildup.

5. The print engine of claim 3 wherein the substrate is covered by a nonstick coating to reduce surface energy.

6. The print engine of claim 3 wherein the nonstick coating is comprised of a high contact angle, low surface energy material.

7. The print engine of claim 6 wherein the nonstick coating is comprised of at least one of a polymer, fluoropolymer, inorganic, nano-material or composite.

8. The print engine of claim 3 wherein the substrate includes a plurality of holes to provide a vacuum.

9. The print engine of claim 3 wherein the substrate comprises a metal.

10. The print engine of claim 1 further comprising a roller to guide the print medium over the preheat platen.

11. A printing system comprising:
a first print engine to print first content on a web of paper; and
a second print engine to print second content on the web of paper, and including:
a preheat platen to heat the web of paper prior to applying the second content; and
a substrate formed to cover the preheat platen to prevent melting of the first content.

12. The printing system of claim 11 wherein the substrate is thermally conductive to enable heat to pass from the preheat platen to the print through the substrate.

13. The printing system of claim 12 wherein the substrate is electrically conductive.

14. The printing system of claim 13 wherein the substrate has a high surface conductivity capable of dissipating static electricity buildup.

15. The printing system of claim 13 wherein the substrate is covered by a nonstick coating to reduce surface energy.

16. The printing system of claim 13 wherein the nonstick coating is comprised of a high contact angle, low surface energy material.

17. The printing system of claim 16 wherein the nonstick coating is comprised of at least one of a polymer, fluoropolymer, inorganic, nano-material or composite.

18. The printing system of claim 13 wherein the substrate includes a plurality of holes to provide a vacuum.

19. The printing system of claim 13 wherein the substrate comprises a metal.

20. The printing system of claim 11 wherein the second print engine further comprises a transfer medium to apply the second content.
